(19) United States
(12) Patent Application Publication
(10) Pub. No.: US 2002/0184354 A1
(43) Pub. Date: Dec. 5, 2002

(54) System and method for managing status notification messages within communication networks

(76) Inventors: William F. McKenzie, Raleigh, NC (US); Kelly A. Revels, Selma, NC (US)

Correspondence Address: Daniel J. Santos, Esq., Thomas, Kayden, Horstemeyer & Risley, L.L.P., Suite 1750, 100 Galleria Parkway, Atlanta, GA, 30339, US

(21) Appl. No.: 09/873,684

(22) Filed: Jun. 4, 2001

(51) Int. Cl. G06F 15/173

(52) U.S. Cl. 709/223

(57) ABSTRACT

System and method for managing notification messages related to statuses, abnormalities and exceptions within a communication network. Generally, a computer is utilized comprising software stored within the computer defining functions to be performed, and a processor configured by the software to perform the steps of: receiving a notification message; indexing a notification message to a status within a communication network; retrieving rules for processing the notification message; determining one or more pre-defined managed correlation orbs in which to store the notification message; retrieving both a notification message textual definition and topographical data, wherein the topographical data is used to create a graphical diagram of the overall communication network and affected segment; and transmitting the notification message textual definition and graphical diagrams to operations personnel for any required further action.

### TECHNICAL FIELD

The present invention is generally related to communication networks, and more particularly, is related to managing status notification messages.

### BACKGROUND OF THE INVENTION

Computer/network devices, such as, but not limited to, routers, switches, hubs, and servers, that are connected to communication networks, typically report exceptions and abnormalities associated with the network by generating messages that are “logged” by a detecting/reporting device or sent to a central management station. These notification messages that are sent to the central management station report device and network abnormalities from many diverse products and technologies, as well as service problems.

Presently, there are hundreds of manufacturers of computer/network type devices, software, and services that generate thousands of unique notification messages. Some larger manufacturers have hundreds of diverse products and models that do not share commonality in the reporting of abnormalities due to the many autonomous development organizations within the company, as well as from mergers with, and acquisitions of other manufacturers. These notification messages have unique product identifiers, product centric text, and non-standard style formats, as well as inconsistent technical level content. Because of this, very few of these notification messages are understandable by the network operations personnel and require specialized expertise for each manufacture, service, and/or technology. Not only are the notification messages often cryptic, they are also not presented in a manner that allows relationships between the notification messages to be identified, thereby hindering analysis.

Many of the notification messages report status with numerical values representing a status or textual meaning of parts or the entire message. These are referred to as enumerated values. These enumerations are unique to each product and technology, requiring the specialized applications to translate the enumerated values to human readable format. Many products do provide systems or element management applications that can be used to process their notification messages. These applications are often very product centric and complex to install, configure, and use. However, analysis and correlation across the entire network infrastructure requires a single central process, which becomes almost impossible in the heterogeneous network environments of today.

Simple network management protocol traps (SNMP traps) are one example of notification messages. It is not unusual in some medium to large communication networks for millions of these notification messages to be generated on a daily basis. In addition to those notification messages reporting software errors, service errors, and device errors, network management applications typically perform status polling or network interface reachability monitoring that often results in the generation of additional notification messages to report these reachability issues. All of these notification messages are typically logged to a single file, where they reside until they are eventually archived for long-term storage.

A single network circuit failure can result in multiple notification messages reporting device errors, software errors, and service errors related to multiple symptoms of the failed circuit, as well as notification messages that may not be related to the specific circuit problem. Simultaneously, the network management application will be generating hundreds of notification messages reporting the inability to reach interface addresses in the communication network as a result of the circuit failure.

Another example is where multiple network devices are connected together using a network segment such as a wide area network (WAN), local area network (LAN), or metropolitan area network (MAN), and the “circuit” connecting them is erratic or unstable and continuously transitions between a good state and a bad state. In this case, notification messages reporting device errors, software errors, and service errors will be generated reporting each transition of the single erratic circuit. In addition to these network-detected exceptions, network users may be impacted by this erratic circuit, resulting in many additional notification messages being reported.

The complexities of processing high volumes of notification messages, determining the device errors, software errors, and service errors conveyed therein, analyzing the errors to determine required actions, and presenting the required actions to operations personnel are readily apparent. Although extensive analysis can be performed and a problem identified, the operation personnel do not always grasp the “big picture” and how a single function can severely impact overall communication functionality.

Operation managers have been struggling with providing solutions to this most pressing need, managing complex communication networks. The cost of the hardware required to support the very complex network management applications is staggering. In addition to this high cost, extensive training and experience is required to install, configure, customize, and operate the many product unique management applications. Network operation managers have found that it is practically impossible to build or maintain staff to cover the many products and technologies included in modern communication networks. As well, in many cases, critical status notification messages are logged with millions of other messages, with no indication of the critical notification message presented to the responsible personnel because the meaning and importance of the notification message was not understood.

Thus, there is a need in the industry to address these and/or other deficiencies and inadequacies.

### SUMMARY OF THE INVENTION

The present invention provides a system and method for managing communication networks. Generally, describing the structure of the notification message management system, a processor is utilized which is configured to accept a plurality of notification messages. Each of the plurality of notification messages corresponds to a network device and a status within the network. A storage device is also provided which is in communication with the processor, wherein the storage device stores a plurality of notification messages and related managed correlation orbs. The storage device is also configured to store a set of rules designed to correlate the notification messages with the managed correlation orbs, wherein the correlation includes storing each of the plurality of notification messages in one or more of the managed correlation orbs to which the set of rules designates that the notification message corresponds.

The present invention may also be viewed as providing a method for managing notification messages within a communications network. Briefly, one such method involves the steps of: receiving a notification message, the notification message corresponding to a network device and a status within the network; providing a storage device having managed correlation orbs; determining the managed correlation orbs to which the notification message is related; storing the notification message in the one or more managed correlation orbs as identified; in response to a determination of a notification message of interest, retrieving rules for processing the notification message of interest; retrieving a notification message textual definition corresponding to the notification message of interest; retrieving topographical data corresponding to the notification message of interest; and creating a graphical diagram from the topographical data.

Other features of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The present invention will be more fully understood from the detailed description given below and from the accompanying drawings of the preferred embodiments of the invention, which, however, should not be taken to limit the invention to the specific embodiments enumerated, but are for explanation and for better understanding only. Furthermore, the drawings are not necessarily to scale, emphasis instead being placed upon clearly illustrating the principles of the invention. Finally, like reference numerals in the figures designate corresponding parts throughout the several drawings.

FIG. 1 is a schematic diagram of a communication network system in which the notification message management system may be implemented.

FIG. 2 is a block diagram further illustrating the notification message management system of FIG. 1.

FIG. 3 is a block diagram further illustrating the database of the notification message management system shown in FIG. 2.

FIG. 4 is a flow chart illustrating the architecture, operation, and functionality performed in accordance with the notification message management system of FIG. 2.

FIG. 5 is a flow chart illustrating the architecture, operation, and functionality performed in accordance with the notification message management system of FIG. 2.

FIG. 6 is a schematic diagram of a graphical representation of a notification message produced by the notification message management system program of FIG. 2.

### DETAILED DESCRIPTION OF A PREFERRED EMBODIMENT

Embodiments of the present invention provide for a system and method of managing notification messages derived from a communication network. The following is a brief summary of a preferred embodiment of the present invention. Generally, the content and relevance of a notification message is identified by a notification message identifier, such as an SNMP OID, and then stored in pre-established managed correlation orbs, an orb being a relational grouping. The content of the notification messages can include, but is not limited to, the status of network devices, protocols, functions, hardware, software, circuits, or any other entity associated with a communication network of which the status would aid in managing the communication network. The managed correlation orbs are defined within a database with regard to structural, functional and logical relational concerns. For example, typical managed correlation orbs could include, but are not limited to, specific network devices, various segments of the communication network (WAN, LAN, or MAN), or various functions such as security concerns. Once the notification messages have been stored within the proper managed correlation orbs, the system determines what notification messages require attention from operations personnel to maintain the overall health of the communication network. Once determined, the notification message is used to retrieve both standardized text and any product specific text necessary for operations personnel to correct the exception or abnormality conveyed by the meaning of the original notification message. As well, topographical data is retrieved that permits the present invention to create a graphical representation of the affected devices, software, services or portions of the communication network. The graphical representation is intended to facilitate understanding of the exception or abnormality by the operations personnel.

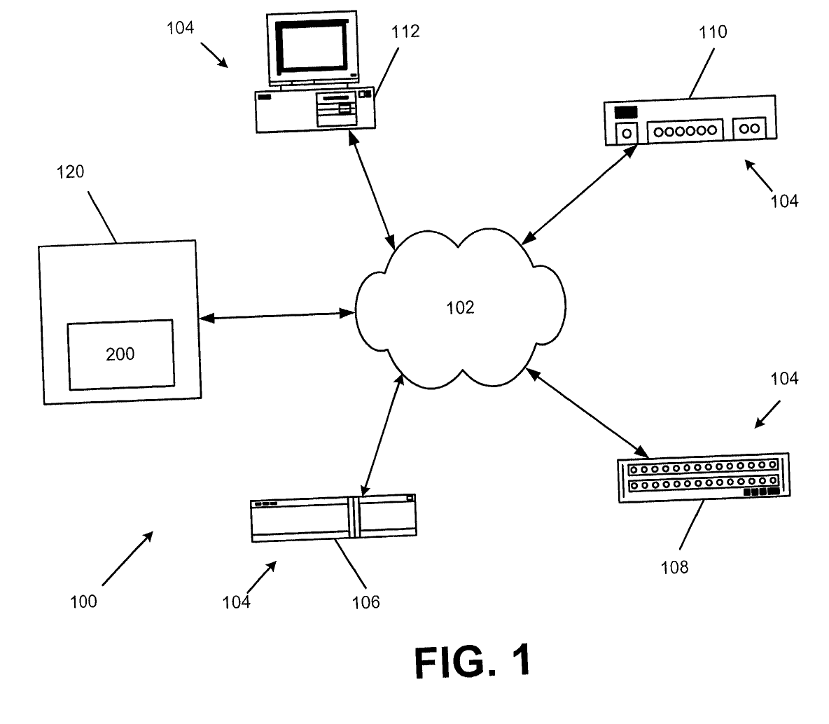

FIG. 1 is a schematical diagram of a communication network 100 configured to process notification messages, both unsolicited and prompted, thereby facilitating the overall health and maintenance of the communication network 100. Communication network 100 comprises a plurality of network nodes 104 each of which is configured to communicate with a central management station 120 via a communication cloud 102. Alternatively, communication may be -provided via a local loop, digital subscriber line, plain old telephone service line, or any other -means of communication. As shown, the central management station 120 includes a notification message management system (NMMS) 200.

Communication network 102 may be any type of communication network employing any network topology, transmission medium, or network protocol. For example, communication network 102 may be a local area network (LAN), a metropolitan area network (MAN), a wide area network (WAN), any public or private packet-switched or other data network, including the Internet, circuit-switched networks, such as the public switched telephone network (PSTN), wireless networks, or any other desired communication infrastructure.

Network nodes 104 may be any of a variety of network and/or computer devices that are configured to communicate with central management station 120 via the communication cloud 102. For example, as illustrated by FIG. 1, network node 104 may be a router 106, a multiplexer 108, an encryption device 110, a personal computer 112, or any other known or future device that supports communications within the network 100.

As understood by one of ordinary skill in the art, the precise configuration of communication network 102 is not critical. The important aspect of communication network 102 is that the central management station 120 comprises the NMMS 200, which is configured to efficiently manage notification messages originating at the network nodes 104. More importantly, central management station 120 facilitates analyzing and disseminating the relevant information contained in notification messages, thereby maintaining the health of the communication network 100.

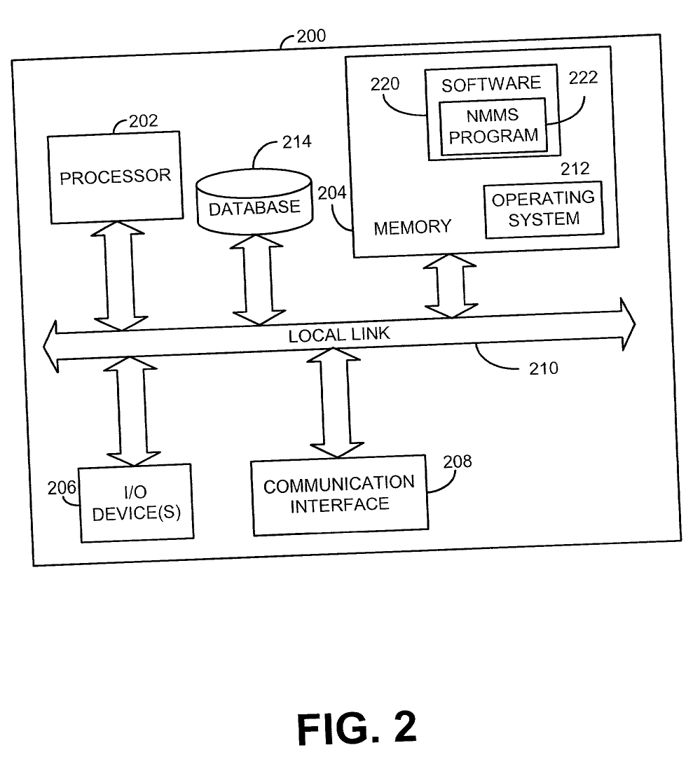

The NMMS 200 can be implemented in a computer system as illustrated in FIG. 2, which is capable of communicatively coupling with a communication network 100. The NMMS 200 includes a notification message management system program (hereinafter NMMS program) 222. Preferably, the NMMS program 222 is implemented in software, as an executable program, and is executed by a special or general-purpose digital computer, such as a personal computer (PC; IBM-compatible, Apple-compatible, or otherwise), workstation, minicomputer, or mainframe computer.

Generally, in terms of hardware architecture, as shown in FIG. 2, the computer includes a processor 202, memory 204, one or more input and/or output (I/O) devices 206 (or peripherals), a database 214, and a communication interface 208 that are communicatively coupled via a local link 210. The local link 210 can be, for example but not limited to, one or more local buses or other wired or wireless connections, as is known in the art. The local link 210 may have additional elements, which are omitted for simplicity, such as controllers, buffers (caches), drivers, repeaters, and receivers, to enable communication. Further, the local interface may include address, control, and/or data connections to enable appropriate communications among the aforementioned components. Communications interface 208 is provided within the computer to allow the computer to be communicatively coupled with the communication network 100 (FIG. 1). A network interface card (not shown) may be provided for connection to the communication interface 208 to allow such communication.

The processor 202 is a hardware device for executing the software 220 that can be stored in memory 204. The processor 202 can be any custom made or commercially available processor, a central processing unit (CPU), an auxiliary processor among several processors associated with the computer, a semiconductor based microprocessor (in the form of a microchip or chip set), a macroprocessor, or generally any device for executing software instructions. Examples of suitable commercially available microprocessors may be, but are not limited to: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 204 can include any one or combination of volatile memory elements (e.g., random access memory (RAM, such as DRAM, SRAM, SDRAM, etc.)) and nonvolatile memory elements (e.g., ROM (read only memory), hard drive, tape, CDROM, etc.). Moreover, the memory 204 may incorporate electronic, magnetic, optical, and/or other types of storage media. Note that the memory 204 can have a distributed architecture, where various components are situated remote from one another, but can be accessed by the processor 202.

The software 220 in memory 204 may include one or more separate programs, each of which comprises an ordered listing of executable instructions for implementing logical functions. In the example of FIG. 2, the memory 204 includes the software 220 comprising at least the NMMS program 222, and a suitable operating system (O/S) 212. A nonexhaustive list of examples of suitable commercially available operating systems 212 may be, but is not limited to: a Windows operating system from Microsoft Corporation, a netware operating system available from Novell, Inc., or a UNIX operating system, which is available for purchase from many vendors, such as Hewlett-Packard Company, Sun Microsystems, Inc., and AT&T Corporation. The O/S 212 essentially controls the execution of computer programs within the computer and provides scheduling, input-output control, file and data management, memory management, and communication control and related services.

The NMMS program 222 can be a source program, executable program (object code), script, or any other entity comprising a set of instructions to be performed. When a source program, then the program needs to be translated via a compiler, assembler, interpreter, or the like, which may or may not be included within the memory 204, so as to operate properly in connection with the O/S 212. Furthermore, the NMMS program 222 can be written as an object oriented programming language, which has classes of data and methods, or a procedure programming language, which has routines, subroutines, and/or functions, for example, but not limited to, C, C++, Pascal, Basic, Fortran, Cobol, Perl, Java, and Ada.

The I/O devices 206 may include input devices, for example but not limited to, a keyboard, mouse, scanner, microphone, etc. Furthermore, the I/O devices 206 may also include output devices, for example but not limited to, a printer, display, etc. Finally, the I/O devices 206 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer is a PC, workstation, or the like, the software 220 in the memory 204 may further include a basic input output system (BIOS) (omitted for simplicity). The BIOS is a set of essential software routines that initialize and test hardware at startup, start the O/S 212, and support the transfer of data among the hardware devices. The BIOS is stored in ROM so that the BIOS can be executed when the computer is activated.

When the computer is in operation, the processor 202 is configured to execute software stored within the memory 204, to communicate data to and from the memory 204, and to generally control operations of the computer pursuant to the software 220. The NMMS program 222, located within the software 220, and the O/S 212, in whole or in part, but typically the latter, are read by the processor 202, perhaps buffered within the processor 202, and then executed.

The NMMS 200 of the present invention can be implemented in software, firmware, hardware, or a combination thereof In the preferred embodiment of the invention, which is intended to be a non-limiting example, a portion of the system 200 is implemented in software. The software portion of the NMMS 200 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The NMMS program 222 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Where the NMMS 200 is implemented in hardware, the NMMS 200 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

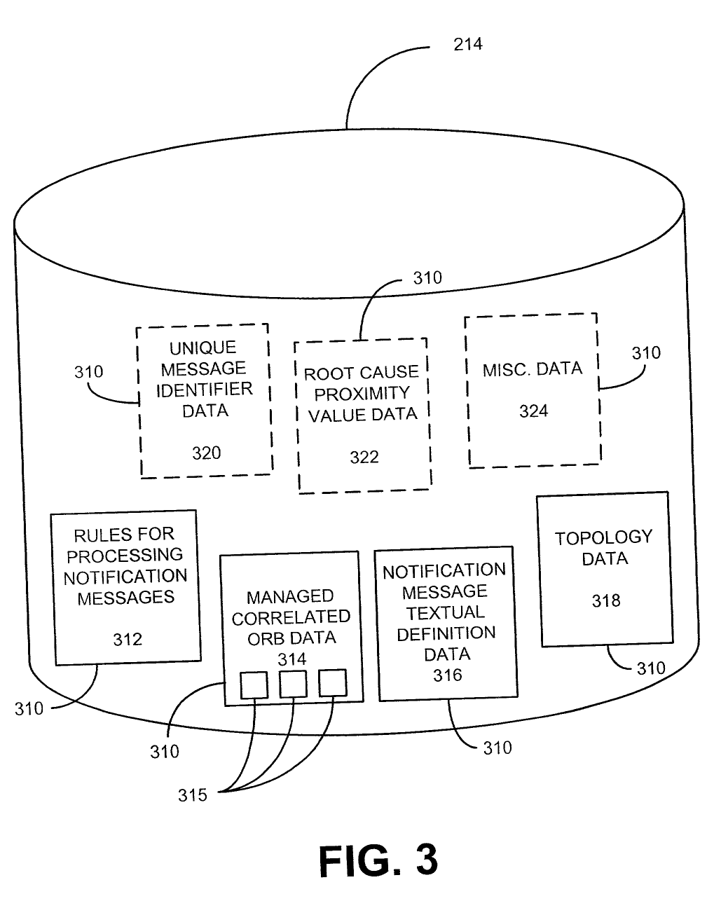

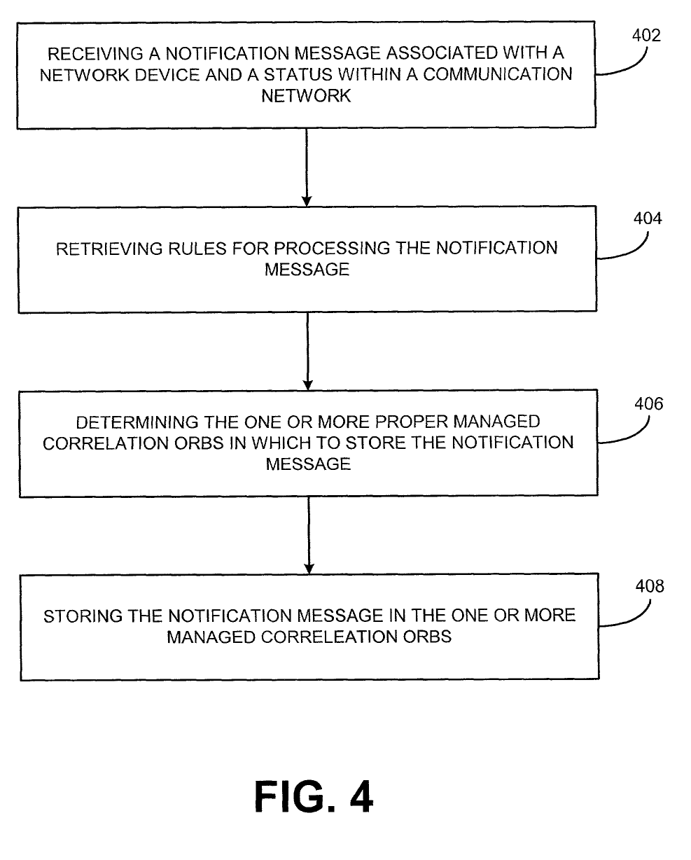

FIG. 3 is a block diagram further illustrating the database 214 of FIG. 2. Within database 214 are a number of data sets 310 accessed by the NMMS program 222 during processing of the notification messages. These include, but are not limited to, rules for processing notification messages 312, managed correlation orb data 314, notification message textual definition data 316, and topology data 318. Also shown in FIG. 3 are the data sets 310 unique message identification data 320 and root cause proximity value data 322. These data sets 320, 322 are shown with dashed lines because although useful in managing notification messages, these data sets 320, 322 are not directly related to this invention, but are included for completeness. The relevance of these data sets 320, 322 to the present invention will be discussed briefly in the discussion of FIG. 4, however, an in depth description of a few of these portions of database 214 are presented in co-pending U.S. patent applications entitled “System and Method for Determining and Presenting Network Problems,” having attorney docket number 60104.1690, and “System and Method for Processing Unsolicited Messages,” having attorney docket number 60104.1720, both of which having been filed on even date herewith, the contents of which are incorporated herein by reference. As well, miscellaneous data set 324 represents any other data sets that may be determined in the future to facilitate managing a communication network.

In general, the NMMS program 222 is designed to implement functions such as, but not limited to, receiving notification messages related to associated notification message definitions and applicable data stored in the database 214, retrieving rules for processing each notification message from the database 214, determining one or more of a plurality of pre-determined managed correlation orbs that is appropriate for storing the notification message, and storing the notification message in the appropriate one or more pre-established managed correlation orbs as determined by the program. FIG. 4 is a flow chart illustrating an overview of a first embodiment of the NMMS program 222. Prior to the NMMS program 222 receiving a notification message that represents a notification message defined in the database 214 (FIG. 2), the notification message must first be indexed to the proper notification message entry in the database. As noted above, this step is not necessarily a part of the NMMS program 222, and is only briefly discussed here to clarify the functionality of the present invention. Upon receiving a notification message at the central management station 120, the unique message identifier of the notification message is determined and used to index the unique message identification data set 320 of database 214. The meaning of the notification message as modified by variable properties is also determined. Using the unique message identifier and the meaning of the notification message, a numeral index is retrieved that will represent the message notification in all subsequent processing. Next, the notification message is assigned a pre-determined root cause proximity value from the root cause problem data set 322. Root cause proximity values facilitate the determination of the highest probability of identifying the actual root cause conveyed by the notification message since the root cause proximity values can be compared to all other root cause proximity values on a standardized scale. Again, the step of assigning root cause proximity values to the notification messages is only briefly discussed as it is not required by the present invention. An in depth discussion of root cause proximity values is presented in co-pending U.S. patent application entitled “System and Method for Determining and Presenting Network Problems,” noted previously.

Referring now to FIG. 4, the NMMS program 222 receives the notification message, preferably represented by a numeral integer as mentioned above, as shown in block 402. Next, the NMMS program 222 accesses the rules for processing notification messages data set 312 and retrieves the rules that define how the notification message will be processed, as shown in block 404. The NMMS program 222 uses the processing rules retrieved in block 404 to determine in which one or more of the pre-established managed correlation orbs 315 (FIG. 3) of the pre-established managed correlation orb set 314 the notification message belongs. Once the proper one or more of the pre-established managed correlation orbs 315 have been determined, the notification message and its associated root cause proximity value are stored therein, as shown in block 408. The pre-established managed correlation orbs 315 are selected such that notification messages related to various devices, functions, segments, and other relational organization defined by the database within the communication network 100 will be stored together in the pre-established managed correlation orbs 315 that provide relational significance between the notification messages.

Each of the pre-established managed correlation orbs 315 (FIG.3) can be further divided into unique instances. For example, if one pre-established managed correlation orb receives all notification messages pertaining to WANs within the communication network 100, that pre-established managed correlation orb can further include individual entries for each WAN segment, each one pertaining to an individual WAN in the communication network 100. This facilitates analysis of the large quantity of notification messages by making it easier to map trends in the notification messages as well as place the information conveyed by those messages within logical groupings.

This efficient method of assigning large volumes of notification messages to pre-established managed correlation orbs provides the foundation for subsequent problem isolation, identification, and ultimately resolution. As noted earlier, the root cause proximity value indicates the highest probability of identifying the actual root cause represented by the notification message to which the root cause proximity value is assigned. Analysis of the root cause proximity values allows a determination of what notification messages represent abnormalities that need to be addressed by operations personnel. The analysis function is not an element of the present invention, and is therefore not addressed here. However, an embodiment of the present invention is configured to further process those notification messages selected for assessment by operations personnel through the above noted analysis.

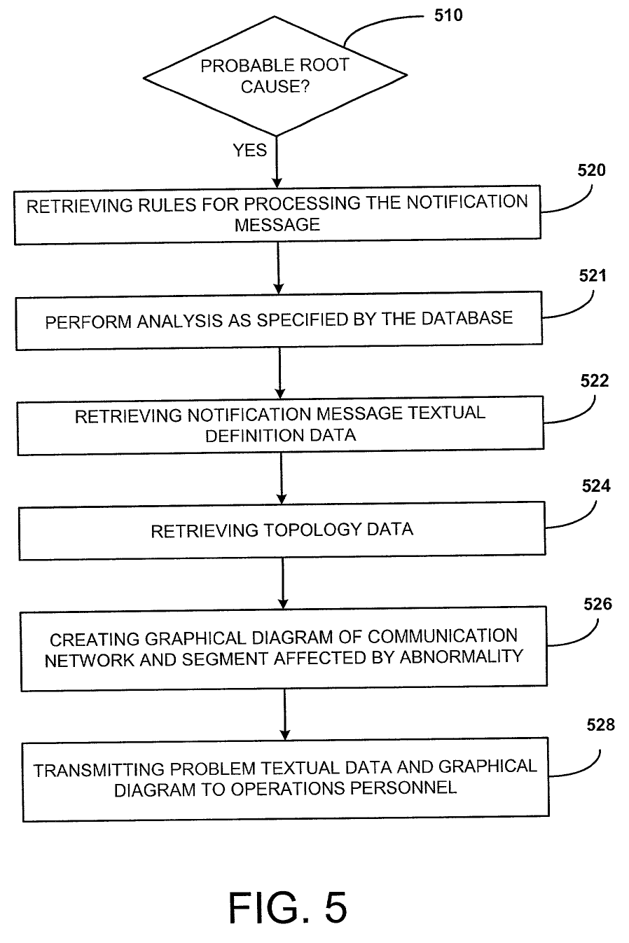

In general, as well as those functions discussed with regard to FIG. 4, the NMMS program 222 is designed to further implement functions such as, but not limited to, receiving a notification message selected through an analytical process, retrieving rules from a database that governs the further processing of the notification message, retrieving standardized textual messages related to the notification message, retrieving topology data concerning the abnormality disclosed by the notification message, creating graphical diagrams from the topology data, and presenting the textual messages and graphical diagrams to operations personnel for action. FIG. 5 illustrates an overview of these functions of an embodiment of the NMMS program 222 which incorporates these additional functions.

During the analysis of the notification messages and their assigned root cause proximity values, if a notification message is determined to not require action by operations personnel, the notification message will remain in the pre-determined managed correlation orb 315 (FIG. 3), or managed correlation orbs, in which it was originally stored. This will allow these notification messages to be archived and examined as a historical record of trends within the communication network 100. If during the analysis step, as shown in block 510, it is determined a notification message is the most probable root cause (highest RCP value), then the NMMS program 222 enters the rules for processing data set 312 of database 214 and retrieves those rules specific to further processing that notification message, as shown in block 520. Note that only the most probable root cause notification messages require extensive analysis, as shown in block 521. Block 521 is not a portion of the present invention and is only provided for clarity. Therefore, block 521 is shown with a dotted line. Next, the S program 222 uses the processing rules retrieved in block 520 to enter the database 214 set notification message textual definition data 316 and retrieve the standardized text relevant to the abnormality in the communication network 100 represented by the notification message, as shown in block 522. The standardized text includes, but is not limited to, description of the problem, probable cause, impact to functioning of the communication network 100, and required remedial actions. In addition to standardized textual messages, where a notification message requires device specific text, that text is retrieved from the database 214 as well. Next, the NMMS program 222, again using the processing rules, accesses the data set topology data 318 and retrieves that data necessary for the NMMS program 222 to construct a graphical representation of the abnormality disclosed by the notification message selected for further action, as shown in block 524.

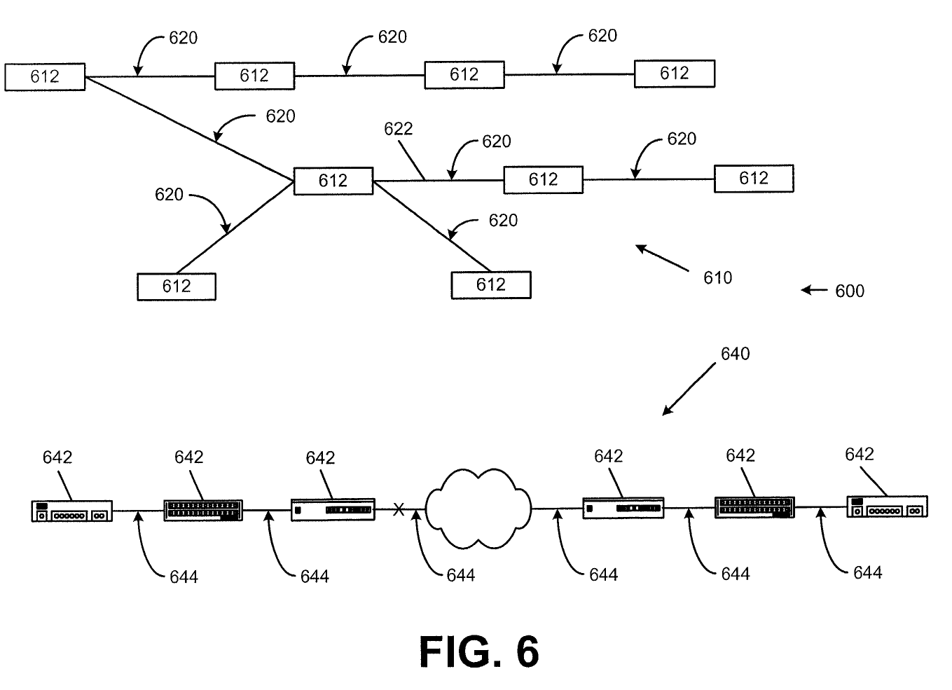

Once the topology data has been retrieved, the NMMS program 222 creates the graphical representation, as shown in block 526. In the preferred embodiment, the graphical representation 600 (FIG. 6) includes, but is not limited to, a general graphical representation 610 of a portion of the communication network 100 (FIG. 1) noting the portion thereof affected by the abnormality, and a detailed graphical representation 640 of the affected segment. In the example shown, the general graphical representation 610 of a portion of the communication network 100 comprises remote locations 612 connected by WAN segments 620, with the WAN segment affected by the abnormality, WAN segment 640, being indicated by highlighting.

Once the general location of the abnormality within the communication network 100 has been indicated, a detailed graphical representation 640 of the affected WAN segment 622 is produced. Detailed graphical representation 640 depicts the various network components 642 and connections 644 that comprises WAN segment 622, but are not shown in the graphical representation of the high level portion of the communication network 610. As well, the actual network components 642 or connection 644 that is the source of the abnormality is indicated, here by an “X.” Any suitable means for indicating the source or location of the abnormality is allowable. Note that any number of network components 642 may be indicated, up to but not necessarily including, all of them, and that WAN segments 620 have been referred to here only by way of example.

It should be emphasized that the above-described embodiments of programmable devices, user support control center, and system, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and protected by the following claims.

Therefore, having thus described the invention, at least the following is claimed:

1. A method for handling notification messages generated within a communication network, the method comprising the steps of:
receiving information corresponding to a plurality of notification messages, each of the plurality of notification messages corresponding to a specific network device and a status within the communication network;
providing a storage device having data arranged such that pre-established managed correlation orbs within the storage device are identified, the pre-established managed correlation orbs for determining a relational correspondence between the received information and an associated notification message;
determining at least one specific pre-established managed correlation orb to which the received information and the associated notification message is related; and
storing the received information and the associated notification message in the at least one specific pre-established managed correlation orb identified by the determining step.

2. The method of claim 1, further comprising the step of defining a plurality of unique instances within each pre-established managed correlation orb.

3. The method of claim 2, further comprising the step of determining at least one unique instance within the pre-established managed correlation orbs to which the received information and the associated notification message are related and storing the received information within the at least one unique instances.

4. The method of claim 1, wherein the notification message is represented by an integer that is an index to a notification message definition stored in the storage device.

5. The method of claim 1, wherein the status within the communication network includes one of a network device, a protocol, a function, a circuit, a program, or a chassis.

6. The method of claim 1, further comprising the step of:
receiving one of the plurality of notification messages;
entering the storage device with the one of the plurality of notification messages; and
retrieving rules for processing the one of the plurality of notification messages, the rules being stored in the storage device.

7. The method of claim 6, further comprising the step of retrieving a notification message textual definition corresponding to the one of the plurality of notification messages, the notification message textual definition being stored in the storage device.

8. The method of claim 7, wherein the notification message textual definition comprises at least a problem description, a probable cause, and remedial actions.

9. The method of claim 7, further comprising the step of:
retrieving topographical data stored in the storage device corresponding to the one of the plurality of notification messages; and
creating a first graphical diagram of the communication network, wherein a segment of the communication network diagram corresponding to the information conveyed by the one of the plurality of notification messages is indicated.

10. The method of claim 9, further comprising creating a second graphical diagram of the indicated segment of the communication network diagram, wherein the second graphical diagram includes a plurality of graphical depictions of both a plurality of network devices present in a portion of the communication network that corresponds to the indicated segment of the communication network graphical diagram and a plurality of connections therebetween.

11. A system for processing notification messages, the system comprising:
a processor, the processor configured to accept an input, the input including a plurality of notification messages, each of the plurality of notification messages corresponding to a network device and a status within a communication network;
a plurality of memory elements, the plurality of memory elements comprising a plurality of pre-established managed correlation orbs and capable of storing the plurality of notification messages; and
a storage device in communication with the processor, the storage device configured to store a set of rules, the set of rules designed to correlate the plurality of notification messages with the plurality of pre-established managed correlation orbs, wherein the correlation includes storing each of the plurality of notification messages in at least one specific of the plurality of pre-established managed correlation orbs to which the set of rules designate the notification message corresponds.

12. The system of claim 11, wherein the plurality of pre-established managed correlation orbs is designated with regard to structural, logical, associational or functional correspondence within the communication network.

13. The system of claim 11, wherein each pre-established managed correlation orb further includes unique instances.

14. The system of claim 11, wherein the storage device is further configured to provide a plurality of processing rules for processing each of the plurality of notification messages.

15. The system of claim 14, wherein the storage device is further configured to provide a notification message textual definition correlating to the status within the communication network.

16. The system of claim 15, wherein the status within a communication network includes one of a network device, a protocol, a function, a circuit, a program, or a chassis.

17. The system of claim 1S, wherein the processor is further configured to produce a graphical diagram of a segment of the communication network to which the notification message textual definition applies.

18. A system for handling notification messages generated within a communication network, the system comprising:
means for receiving information corresponding to a plurality of notification messages, each of the plurality of notification messages corresponding to a specific network device and a status within the communication network;
means for providing a storage device having data arranged such that pre-established managed correlation orbs are identified, the pre-established managed correlation orbs for determining a relational correspondence between received information and an associated notification message;
means for determining at least one specific pre-established managed correlation orb to which the received information and the associated notification message is related; and
means for storing the received information and the associated notification message in the at least one specific pre-established managed correlation orb identified by the determining step.

19. The system of claim 18, wherein the status within a communication network includes one of a network device, a protocol, a function, a circuit, a program, or a chassis.

20. The system of claim 18, further comprising means for defining unique instances within each pre-established managed correlation orb.

21. The system of claim 20, further comprising means for determining the at least one unique instance within the pre-established managed correlation orbs to which the received information and the associated notification message are related and storing the received information and the associated notification message within the at least one unique instance.

22. The system of claim 18, wherein the notification message is represented by a notification message identifier, the notification message identifier being an integer.

23. The system of claim 18, further comprising:
means for entering the storage device with a notification message of interest being one of the plurality of notification messages; and
means for retrieving rules for processing the notification message of interest, the rules being stored in the storage device.

24. The system of claim 23, further comprising means for retrieving the notification message textual definition corresponding to the notification message of interest, the notification message textual definition being stored in the storage device.

25. The system of claim 24, wherein the notification message textual definition comprises at least a problem description, a probable cause, and a remedial action.

26. The system of claim 24, further comprising:
means for retrieving topographical data stored in the storage device corresponding to the notification message of interest; and
means for creating a first graphical diagram of the communication network, wherein a segment of the communication network diagram corresponding to the information conveyed by the notification message of interest is indicated.

27. The system of claim 26, further comprising means for creating a second graphical diagram of the indicated segment of the communication network diagram, wherein the second graphical diagram includes a plurality of graphical depictions of both a plurality of network devices present in a portion of the communication network that corresponds to the indicated segment of the communication network graphical diagram and a plurality of connections therebetween.
